(19) United States
(12) Patent Application Publication
(10) Pub. No.: US 2008/0033713 A1
(43) Pub. Date: Feb. 7, 2008

(54) PREDICTING ENTERED TEXT

(75) Inventor: Sofia BROSTRÖM, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/456,517

(22) Filed: Jul. 10, 2006

(51) Int. Cl. G06F 17/27

(52) U.S. Cl. 704/9

(57) ABSTRACT

A communication device receives a word, provides a first next word candidate list based on the received word, and provides a second next word candidate list based on a received character input by a user of the communication device. At least one word in the second next word candidate list is selected from a list associated with the received word.

### TECHNICAL FIELD OF THE INVENTION

The invention relates to communication devices, and more particularly, to inputting text into communication devices.

### DESCRIPTION OF RELATED ART

Communication devices, such as mobile terminals, may be used by individuals for communicating with users of other communication devices. For example, a communication device may be used to place/receive calls and send/receive text messages to/from other communication devices. Communication devices typically allow the user to enter text, such as text messages, via an alpha-numeric keypad.

### SUMMARY

According to one aspect, a method comprises receiving a word; providing a first next word candidate list based on the received word; receiving an input from a user; and providing a second next word candidate list to the user based on the received input, at least one word in the second next word candidate list being selected from a predetermined list of words that is associated with the received word.

Additionally, the input from a user is a character.

Additionally, the providing the first next word candidate list includes retrieving the first next word candidate list from memory.

Additionally, the providing the second next word candidate list includes providing words selected from a dictionary.

Additionally, the providing the second next word candidate list to the user includes providing words that remain after filtering the first next word candidate list.

According to another aspect, a communication device is provided. The communication device comprises: a memory to store a plurality of first next word candidate lists, a display, and logic configured to receive a word; provide one first next word candidate list of the plurality of first next word candidate lists based on the received word; receive an input from a user; provide a second next word candidate list based on the received input from a user, at least one word in the second next word candidate list being selected from a predetermined list of words associated with the received word; and cause at least a portion of the second next word candidate list to be displayed by the display.

Additionally, the received input from a user is a character.

Additionally, the logic is further configured to receive a selected word from the second next word candidate list.

Additionally, the second next word candidate list is scrollable.

Additionally, the logic is further configured to provide words to the second next word candidate list from a dictionary.

According to another aspect, a computer readable medium having stored thereon a plurality of sequences of instructions is provided. The instructions when executed by at least one processor, cause the processor to receive a word; provide a first next word candidate list based on the received word; and provide a second next word candidate list based on a character input by a user, at least one word in the second next word candidate list being selected from a list associated with the received word.

Additionally, the computer readable medium may further comprise instructions for causing the processor to provide words into the second next word candidate list from a dictionary.

Additionally, the computer readable medium may further comprise instructions for causing the processor to remove words from the list associated with the received word based on the character input by a user.

Additionally, the computer readable medium may further comprise instructions for causing the processor to place words from the first next word candidate list into the second next word candidate list.

Additionally, the first next word candidate list is stored in memory.

According to another aspect a method is provided. The method comprises receiving a character sequence; providing a first next word candidate list based on the received character sequence, the first next word candidate list being determined via a first technique; receiving input from a user; and providing a second next word candidate list, at least one word in the second next word candidate list being determined via the first technique.

Additionally, the providing a second next word candidate list includes providing at least one character sequence determined via a second technique.

Additionally, the providing a second next word candidate list includes displaying the at least one character sequence providing via the first technique as a higher ranking choice than the at least one character sequence provided via the second technique.

According to another aspect, a communication device is provided. The communication device comprises a memory, and logic configured to receive a word, provide a first next word candidate list from the memory based on the received word, the first next word candidate list being determined via a first technique; receive a character input from a user, and provide a second next word candidate list based on the received character input from a user, at least one word in the second next word candidate list being determined via the first technique.

Additionally, the logic is further configured to provide at least one word into the second next word candidate list determined via a second technique; and display the second next word candidate list, wherein the at least one word provided via the first technique is displayed as a higher ranking choice than the at least one word provided via the second technique.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram of an exemplary implementation of a communication device consistent with the invention;

FIG. 2 illustrates an exemplary functional diagram of the communication device of FIG. 1 consistent with the invention;

FIG. 3 illustrates an exemplary data structure consistent with the invention;

FIG. 4 illustrates an exemplary flow diagram of providing a candidate next word list consistent with the invention; and

FIGS. 5A-5F illustrate exemplary processing and displays of a communication device consistent with the invention.

### DETAILED DESCRIPTION OF THE INVENTION

The following detailed description of the invention refers to the accompanying drawings. The same reference numbers in different drawings may identify the same or similar elements. Also, the following detailed description does not limit the invention.

### Exemplary Communication Device

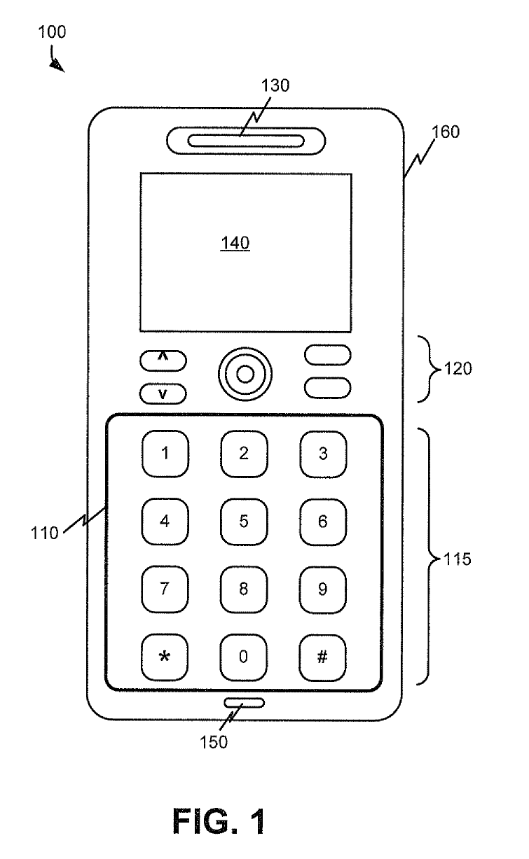

FIG. 1 is a diagram of an exemplary implementation of a communication device consistent with the invention. Communication device 100 (hereinafter communication device 100) may be a mobile communication device. As used herein, a “communication device” and/or “communication terminal” may include a radiotelephone; a personal communications system (PCS) terminal that may combine a cellular radiotelephone with data processing, a facsimile, and data communications capabilities; a personal digital assistant (PDA) that can include a radiotelephone, pager, Internet/intranet access, web browser, organizer, calendar, and/or global positioning system (GPS) receiver; a laptop; a palmtop receiver and/or another type of communication device.

Communication device 100 may include housing 160, keypad 110, control keys 120, speaker 130, display 140, and microphone 150. Housing 160 may include a structure configured to hold devices and components used in communication device 100. For example, housing 160 may be formed from plastic, metal, or composite and may be configured to support keypad 110, control keys 120, speaker 130, display 140 and microphone 150.

Keypad 110 may include devices and/or logic that can be used to operate communication device 100. Keypad 110 may further be adapted to receive user inputs, directly or via other devices, such as a stylus for entering information into communication device 100. In one implementation, communication functions of communication device 100 may be controlled by activating keys 115. Implementations of keys 115 may have character information associated therewith, such as numbers, letters, symbols, etc. For example, the number 2 and the letters “a,” “b” and “c” may be associated with the “2” key, the number 3 and the letters “d,” “e” and “f” may be associated with the “3” key, etc. In another implementation, the keypad 110 may be a “qwerty” type of keypad. The user may select keys 115 to enter, for example, characters, letters, digits, commands, and/or text into communication device 100.

Control keys 120 may include buttons and/or knobs that permit a user to interact with communication device 100 to cause communication device 100 to perform specified actions, such as to display a next word candidate list via display 140, scroll through the next word candidate list, select one of the displayed words on the list, etc.

Speaker 130 may include a device that provides audible information to a user of communication device 100. Display 140 may include a device that provides visual images to a user. For example, display 140 may provide text and a next word candidate list to the user. Display 140 may also provide graphic information regarding incoming/outgoing calls, text messages, games, phonebooks, the current date/time, volume settings, etc., to a user of communication device 100. Display 140 may be implemented as a black and white or a color display.

Microphone 150 may include a device that receives audible information from a user. Microphone 150 may, in some implementations, convert speech or other acoustic signals into electrical signals for use by communication device 100.

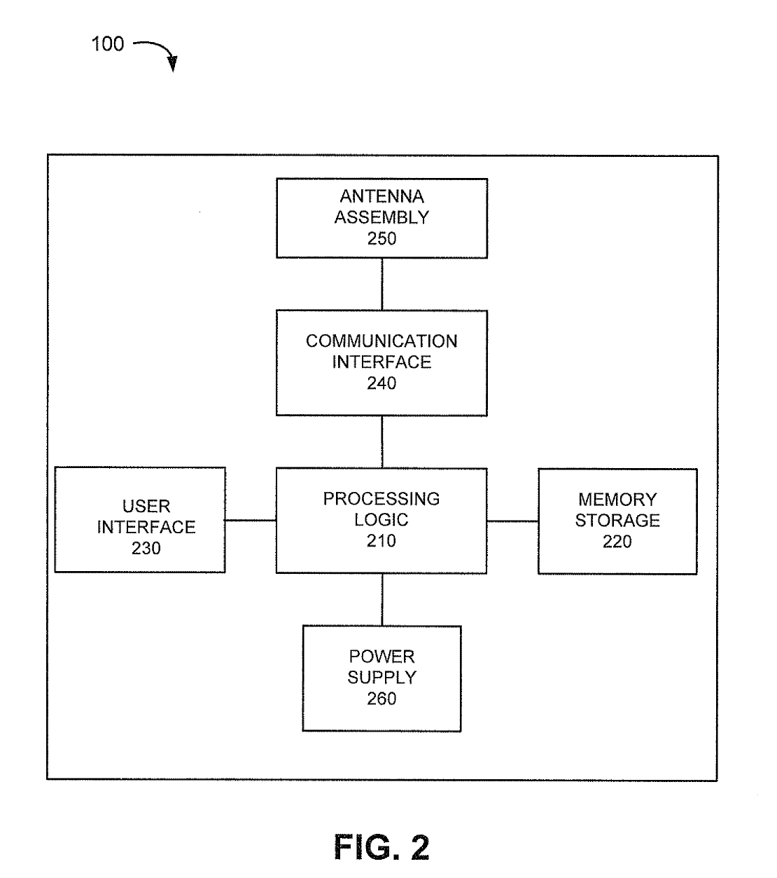

FIG. 2 illustrates an exemplary functional diagram of a communication device, such as communication device 100, consistent with the invention. As shown in FIG. 2, communication device 100 may include processing logic 210, memory storage 220, user interface 230, communication interface 240, antenna assembly 250, and power supply 260.

Processing logic 210 may include a processor, microprocessor, an application specific integrated circuit (ASIC), field programmable gate array (FPGA), or the like. Processing logic 210 may include data structures or software programs to control operation of communication device 100 and its components. Implementations of communication device 100 may use an individual processing logic component or multiple processing logic components, such as processing logic components operating in parallel.

Memory storage 220 may include a random access memory (RAM), a read only memory (ROM), and/or another type of memory to store data and instructions that may be used by processing logic 210. Memory storage 220 may also contain data structures, such as a dictionary and next word candidate lists.

User interface 230 may include mechanisms, such as hardware and/or software, for inputting information to communication device 100 and/or for outputting information from communication device 100, such as display 140 and keypad 110.

Communication interface 240 may include, for example, a transmitter that may convert baseband signals from processing logic 210 to radio frequency (RF) signals and/or a receiver that may convert RF signals to baseband signals. Alternatively, communication interface 240 may include a transceiver to perform functions of both a transmitter and a receiver. Communication interface 240 may connect to antenna assembly 250 for transmission and reception of RF signals. Antenna assembly 250 may include one or more antennas to transmit and receive RF signals over the air. Antenna assembly 250 may receive RF signals from communication interface 240 for transmitting over the air, and receive RF signals over the air for conveying to communication interface 240.

Power supply 260 may include hardware and/or software to provide power to components of communication device 100. For example, power supply 260 may include one or more batteries and/or connections to receive power from other devices, such as an accessory outlet in an automobile, an external battery, or a wall outlet. Power supply 260 may include metering logic to provide the user and components of communication device 100 with information about battery charge levels, output levels, power faults, etc.

As will be described in detail below, communication device 100, consistent with the invention, may perform certain operations relating to dynamically configuring a next word candidate list in response to user inputs and/or in response to instructions associated with processing logic 210. Communication device 100 may perform such operations in response to processing logic 210 executing software instructions contained in a computer-readable medium, such as memory storage 220. A computer-readable medium may be defined as a physical or logical memory device and/or carrier wave.

The software instructions may be read into memory storage 220 from another computer-readable medium or from another device via communication interface 240. The software instructions contained in memory storage 220 may cause processing logic 210 to perform processes that will be described later. Alternatively, hardwired circuitry may be used in place of or in combination with software instructions to implement processes consistent with the invention. Thus, implementations consistent with the principles of the invention are not limited to any specific combination of hardware circuitry and software.

### Exemplary Data Structure

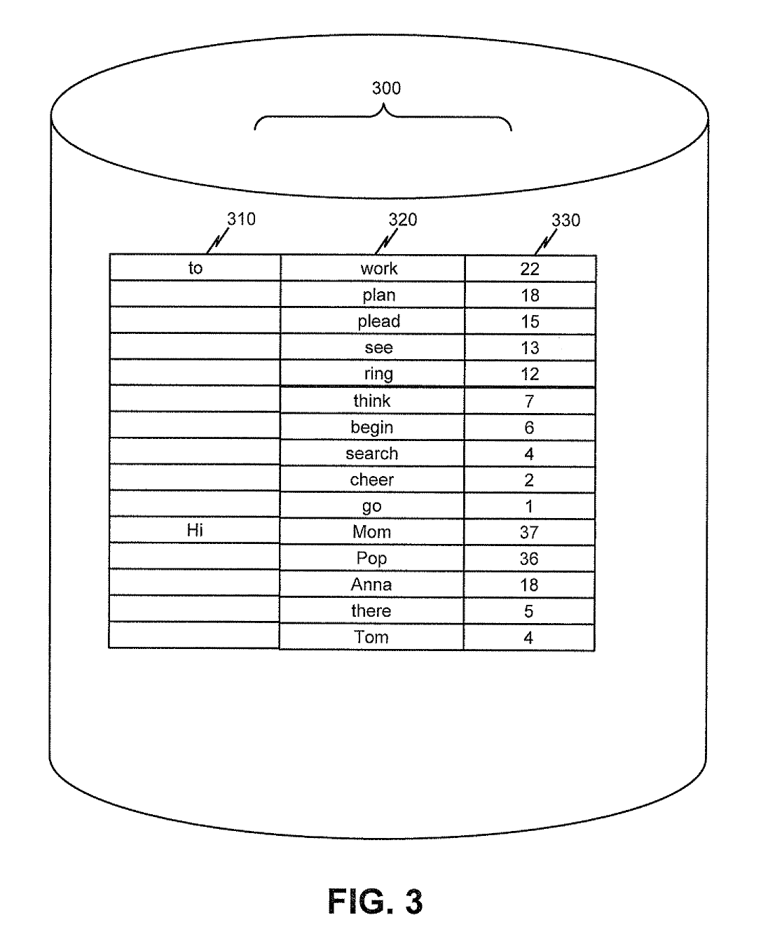

FIG. 3 illustrates exemplary data structure 300 consistent with the invention. In one implementation of the invention, data structure 300 may be stored in memory storage 220.

Column 310 of the exemplary data structure 300 may contain a list of words. In this example, the words “to” and “Hi” are shown. Although two words are shown in FIG. 3, data structure 300 may include hundreds or thousands of words. The words in column 310 may correspond to words that have been entered into communication device 100 by a user. Once a word has been completely entered by the user into communication device 100, the entered word may be accessed in the data structure in column 310 to provide a next word candidate list to the user.

Column 320 of the exemplary data structure 300 may contain a next word candidate list of words that is associated with each word in column 310. The words provided in column 320 may represent the words that are most likely to follow the word in column 310. In one implementation consistent with the principles of the invention, the words in column 320 are determined based on previous text entries into communication device 100. For example, the words most likely to follow the word “to” are “work,” “plan,” “plead,” “see,” “ring,” “think,” “begin,” “search,” “cheer” and “go,” since these words have been most frequently entered into communication device 100 after the word “to.” The words determined to most likely follow the word “Hi” are “Mom,” “Pop,” “Anna,” “there” and “Tom.” The next word candidate lists stored in column 320 may include a single word or multiple words.

Column 330 of the exemplary data structure 300 may contain a counted number of times that each word in column 320 has followed after the associated word in column 310. The stored number in column 330 may be based on the counted number of times the word in column 320 has followed the associated word in column 320, based on the user's previous text entries in one implementation consistent with the invention. For example, the number stored in column 330 may be 22, if the word “work” has been input 22 times after the word “to” as determined by previous text entries. Also for example, column 330 may store the number 18, associated with the word “plan,” and store a 15 associated with “plead,” if for example, the word “plan” has been input 18 times after the word “to,” and the word “plead” has been input 15 times after the word “to.” The counted number that may be stored in column 330 for each word as a candidate next word may be updated as the user of communication device 100 enters text. In this implementation of the invention, for example, the counted number stored in column 330 determines the order that words in column 320 may be stored and displayed. For example, the word with the highest number in column 330 is stored at the top of the list in column 320. In other implementations of the invention, column 330 may store a percentage, where the percentage may indicate the percentage of times the word in column 320 has followed after the associated word in column 310. It will be appreciated that data structure 300 may include other types of character sequences in addition to words. For example, data structure 300 may also include phrases, a sequence of symbols, (e.g., “:)”), numbers etc.

### Exemplary Processing

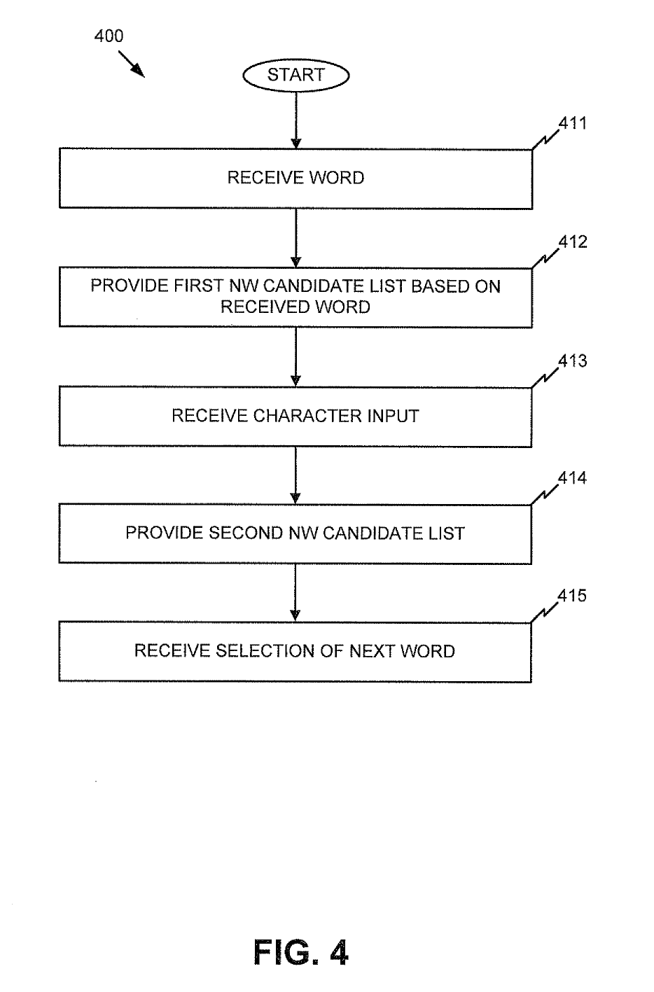

FIG. 4 is a flowchart of an exemplary process 400 for providing next word candidate lists consistent with the invention. The process may begin when a word is received from a user (act 411). For example, if a user enters a word into communications device 100 and enters a space after the word, the word is then received (act 411), as the space indicates that the user is done entering the word. If, for example, a user enters a period to end a sentence, this may also indicate that a word is completely entered, and the word that precedes the period may be received in act 411. A user may also, for example, select a word from a displayed next word candidate list, wherein the selected word may be received (act 411).

Once a word is received, a first next word candidate list may be provided to the user (act 412). For example, based on the received word, communication device 100 may retrieve a first next word candidate list from data structure 300 and provide that list to the user. Communication device 100 may display all or a portion of the list to the user. Using control keys 120, for example, a user may scroll through and/or select a word from the next word candidate list (provided in act 412) or may enter a character of a next word. For example, a user may select a word from the next word candidate list causing the word to be displayed, via display 140, as a word in the text being entered by the user of communication device 100. The selection of a word from the displayed next word candidate list may cause the word to be received (act 415) and another first next word candidate list may be provided based on this received selected word (acts 411 and 412). In one implementation of the invention, if the user does not select one of the words from the first list, but begins to press keys 115 to input characters to spell a next word, this input may be received (act 413). Using the received character input in act 413, a second next word candidate list may be provided to the user (act 414).

In one implementation of the invention, once a character input is received (act 413) words from the first list may be filtered out or removed, as they are no longer possible next word candidates based on the received character. For example, a character may include one or more letters, one or more numbers, punctuation marks or symbols, or combinations thereof. For example, if the user presses the “2” key on keypad 110, words (or character sequences) starting with “a,” “b” and “c” or a “2,” may be provided from the first next word candidate list into the second next word candidate list (act 414), or if a user presses a “b” key on a qwerty type of keyboard, words starting with “b” may be provided from the first next word candidate list into the second next word candidate list (act 414). Also for example, other types of words or symbols may be provided from the first next word list into the second next word candidate list, consistent with characters on the pressed key in keypad 110. In still further implementations of the invention, keypad 110 may be in any type of language, where the specific set of characters associated with a given key may vary depending on the language. In these implementations of the invention, for example, acts 413 and 414 may be repeated each time character input is received by communication device 100. In other implementations of the invention, in addition to providing words from the first next word candidate list associated with the received word stored in memory, additional words may be provided into the second next word candidate list from a dictionary based on the received character (act 414). In another implementation consistent with the invention, redundant words provided by both the dictionary and the first next word candidate list may be filtered, so that a given word is only provided once to the second next word candidate list.

In another implementation consistent with the invention, additional filtering of the first next word candidate list may include removing words from the second next word candidate list that may not meet a predetermined threshold. The predetermined threshold may be in the form of a number, where only words that may have been entered after a given word more than, for example, 4 times as a next word, may be provided into the second next word candidate list. The predetermined threshold number may further be determined by the user, in other implementations of the invention. In still further implementations of the invention, the words provided into the second next word candidate list may be only words remaining after filtering the first next word candidate list based on the received character input from act 413. In any of the above exemplary implementations consistent with the invention, for example, acts 413 and 414 may be repeated each time a character input is received by communication device 100. Once a second next word candidate list has been provided by any of the implementations consistent with the invention, it may be displayed to the user of communication device 100 (act 414).

Implementations consistent with the invention may also include providing the second next word candidate list by displaying one word in a scrollable list of many words, where only one word at a time is displayed from the next word candidate list. Using control keys 120, for example, a user may scroll through and select a word from the first or second next word candidate list. Once a next word candidate list is provided to the user, the user may select a word from the next word candidate list (act 415). For example, a user may scroll through the displayed next word candidate lists using scroll control keys 120, to highlight one word in the displayed list. A user may then select the highlighted word as a next word using control keys 120 (act 415). The selected word may then be displayed, via display 140, within text that a user may be entering into communication device 100. The selected word may then be received (act 411) and another first next word candidate list is provided based on the selected highlighted word received (act 412). If, for example, the desired next word does not appear on the displayed next word candidate list, the user may continue to enter characters via keys on keypad 110, to spell the word. This entered word, not previously on the list, may be added to data structure 300 as a next word candidate for the word that preceded this entered word, and stored in column 320. And, a count of “1” may be associated with this word in column 330.

As an example, assume a user has pressed keys 115 to input the word “Hi” into communication device 100. In response, communication device 100 may retrieve (or generate) a first next word candidate list associated with the word “Hi.” In this example, the first next word candidate list from column 320 of data structure 300 may include the words “Mom,” “Pop,” “Anna,” “there” and “Tom.” Assume, for example, a user presses the “8” key 115 on keypad 110 and assume that the “8” key is associated with the characters “8,” “t,” “u” and “v.” In response, communication device 100 may provide a second next word candidate list. In this example, the second next word candidate list may include the words “there,” “Tom,” “the,” “them” and “those.” In this example, the words “there” and “Tom” may be provided from the first next word candidate list and the words “the,” “them” and “those,” may be provided from a dictionary stored in communications device 100. The user may then select the word “there” from the displayed second next word candidate list.

In this example, as soon as the word “there” is selected, the process continues as the selected word “there,” becomes a received word, and another first next word candidate list is provided from data structure 300 that contains the next words predicted to follow the word “there.”

After each selection of a word (act 415), implementations consistent with the invention may update the counter value (stored in column 330 of data structure 300) of the word in the next word candidate word list. For example, once the word “there” has been selected, its counted number (stored in column 330) may be increased by one, as a candidate next word to follow the word “Hi.”

In the example shown in FIG. 3, the counted value stored in column 330 associated with “Mom” is 37 and the counted value stored in column 330 for “Pop” is 36. If, for example, the user selects the word “Pop” to follow the word “Hi,” this would increase the counted number stored in column 330 for “Pop” to 37. In this implementation of the invention, for example, the counted number stored for each word as a next word candidate in column 330 may be updated as the user enters character sequences into communication device 100.

Implementation consistent with the invention may also, for example, add words to the stored next word candidate lists in data structure 300 as the user continues to enter character sequences into communication device 100. In this manner, implementations consistent with the invention provide next word candidate lists based on a user's previously entered character sequences (e.g., words) and received characters input by a user of communication device 100. For example, the next word candidate list may contain every character sequence (e.g. word) the user has previously entered after a given character sequence. Implementations consistent with the invention may also allow the user to specify the number of next word candidates visible to the user at any one time. For example, a user may configure communication device 100 to display no more than 5 next word candidate choices at one time. In this implementation of the invention, the next word candidate list may contain any number of words, however, only a given number may be displayed at any one time.

In the exemplary implementations of the invention described above, techniques of providing words in the next word candidate lists include providing words from predetermined lists of words from memory and providing words from a dictionary. In this embodiment, words provided from the first technique may be displayed as higher ranking choices than words provided by the second technique. For example, words provided from the first next word candidate list stored in memory, which still remain after filtering based on the received character input, may be displayed above words selected from the dictionary stored in memory 220. For example, the display may provide 5 next words candidates to the user at any one time, however, the entire next word candidate list may include 100 words. In this example, the top 5 choices from the first list provided from memory may be displayed to the user, and when less that 5 words remain from the first next word candidate list after filtering based on character input, words may be supplied from the dictionary list to display a total of 5 words as next word candidate choices. In other implementations of the invention, for example, the second next word candidate list provided may include words from the first next word candidate list used more than a threshold number of times, followed by words from the dictionary, followed by words from the first next word candidate list used below the threshold number of times.

### EXAMPLES

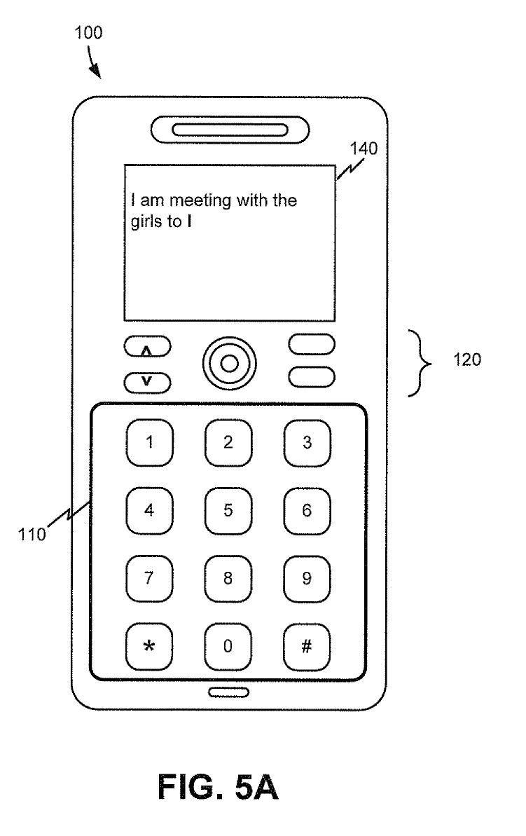

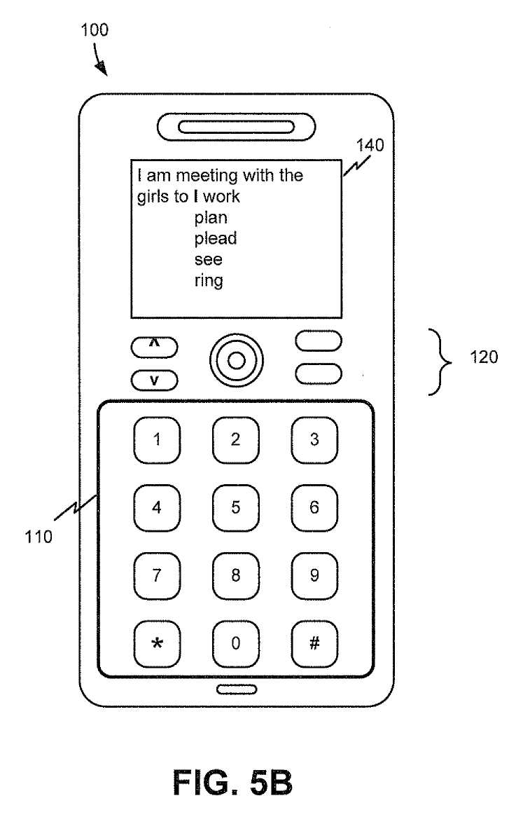

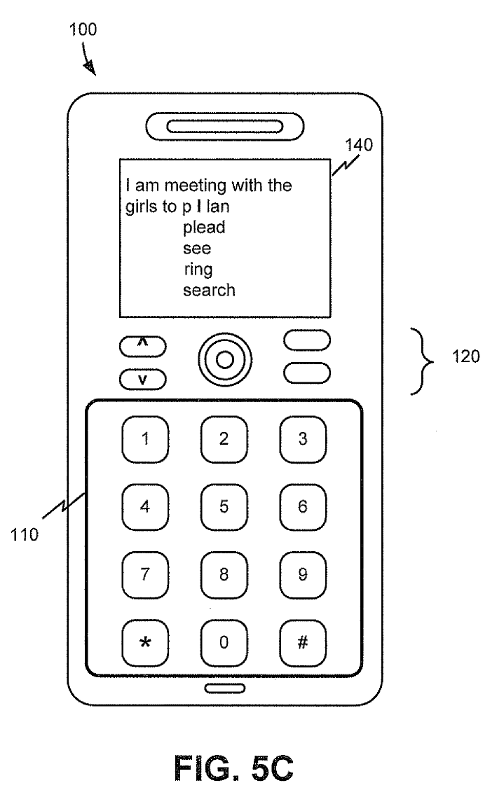

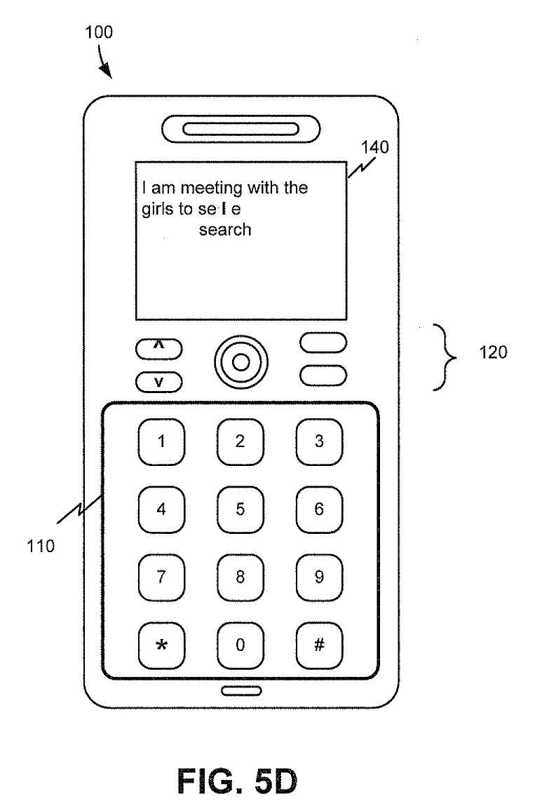

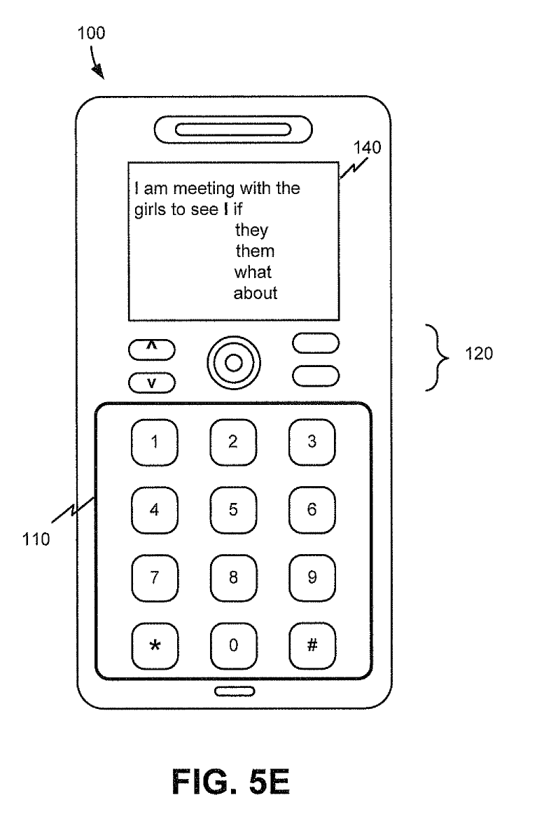

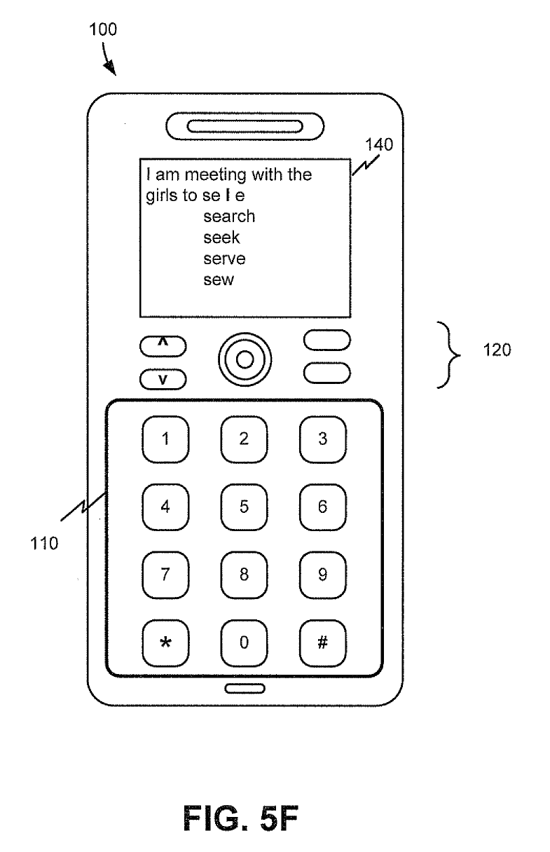

FIGS. 5A-5F illustrate examples of providing next word candidate lists consistent with the invention. The exemplary next word candidate lists are provided by communication device 100, while a user is in the process of inputting character sequences using keys on keypad 110. The exemplary character sequences and next word candidate lists are provided, via display 140 of communication device 100. The exemplary next word candidate lists may be provided, for example, using the data structure of FIG. 3 and the methods described in FIG. 4. In the examples described in FIGS. 5A-5F, next word candidate lists are being provided while exemplary text “I am meeting with the girls to see if they are ready to go” is being entered by a user of communication device 100.

FIG. 5A shows exemplary text displayed to a user of communication device 100 using display 140, consistent with the invention. In this example, the user has just entered the word “to” into communication device 100. The word “to” may have been typed in by the user or may have been selected from a displayed next word candidate list. As described in FIG. 4, a first next word candidate list is automatically provided when a word is completely entered by a user of communication device 100.

FIG. 5B shows the communication device 100 after completely entering or selecting the word “to.” In this example, a first next word candidate list is automatically provided from data structure 300 based on the received word “to.” The list may then be displayed via display 140. In this example, the word “work” is determined to be the most probable next word as determined by the next word candidate list stored in memory 220. The other words in the first next word candidate list (“plan,” “plead,” “see” and “ring”) are displayed in the order as ranked and stored in data structure 300 in FIG. 3.

FIG. 5C shows communication device 100 after the user has entered a first letter of the next word by pressing one of the keys on keypad 110. In this example, the user has pressed the “7” key, indicating that the next word (after “to”) starts with “p”, “q,” “r” or “s.” In response to this received letter input, a second next word candidate list is provided. In this example, the word “plan” is now displayed, via display 140, to the user as the top choice in the displayed second next word candidate list. In this example, the second next word candidate list contains words provided from the first list previously displayed to the user in FIG. 5B. In this example, the word “work” may be filtered out as it does not start with “p”, “q,” “r” or “s.” In this example, the word “search,” which is the highest ranking word in the first next word candidate list stored in column 320 in data structure 300, as illustrated in FIG. 3, may now be displayed. In this example of the invention, the maximum number of words displayed (at any one time) to the user, may be 5 words, where other words that may be contained in the second next word candidate list (that are not currently visible) may be seen by scrolling through the list.

FIG. 5D shows communication device 100 after the user has pressed another key 115 to input the second character of the next word. In this example, the user has pressed the “3” key, indicating that the second character of the next word starts with “3,” “d,” “e>or “f.” In this example, the received character input results in providing another second next word candidate list. In this example, the word “see” and “search” remain possible choices from the second next word candidate list illustrated in FIG. 5C. In this example, the words previously contained in the displayed list shown in FIG. 5C (“plan,” “plead” and “ring”) have been filtered out and not provided into the second next word candidate list based on the received character input. Moreover, as illustrated in FIG. 3, the next word candidate list from data structure 300 does not include any additional word candidates. In this manner, FIGS. 5B-5D illustrate a shrinking list wherein exemplary filtering and removal of words in the previously provided next word candidate list is performed each time an inputted character is received.

FIG. 5E shows communication device 100 after the user has selected the word “see” as the desired next word. In response to the word “see” being entered or selected from the displayed list, another first next word candidate list is automatically provided based on the word “see.” In this example, the words most likely to follow the word “see,” as determined by a next word candidate list stored in memory 220, are “if,” “they,” “them,” “what,” and “about.” In this example, the word “if” is now displayed, via display 140, as the most probable choice of candidate next words that may follow the word “see” in the context of the entered text. In this manner, next word candidate lists may be provided to the user of communication device 100 to facilitate the user's entering of text into communication device 100.

FIG. 5F shows another implementation of the invention in communication device 100 after the user has pressed another key 115 to input the second character of the next word. In this example, candidates from both the first next word candidate list and a dictionary are provided into the second next word candidate list. Using this implementation of the invention for example, FIG. 5F may show the display of communication device 100 subsequent to FIG. 5C. For example, after pressing the “7” key to provide the list shown in FIG. 5C, the user may press the “3” key, indicating that the second character of the next word starts with “3,” “d,” “e” or “f.” In this example shown in FIG. 5F, the received character input results in filtering words from the previous list and providing words from a dictionary into the second next word candidate list. In this example, the words “see” and “search” remain from the previous list, as “plan,” “plead” and ring” have been filtered out based on the “3” key (indicating that the second character of the next word starts with “3,” “d,” “e” or “f”). In this example, the words “seek,” “serve” and “sew” may be provided from a dictionary into the displayed second next word candidate list. In this example, other words such as “re” and “red” that may still be compatible with the “7” key and the “3” key inputs, may be also be provided into the list, however these additional words may be visible to the user after scrolling through the displayed next word candidate list. In this implementation of the invention, for example, words may be filtered out of the previously provided list and additional words may be provided from a dictionary stored in memory 220 for each user entry of a character. For example, with the next word candidate list displayed in FIG. 5F, if the user presses the “7” key (indicating that the third letter of the word starts with “7,” “p,” “q,” “r” or “s”) the only remaining word in the second next word candidate list may be “serve” and a list of words may then be provided from the dictionary stored in memory 220. In this example consistent with the invention shown in FIG. 5F, the words provided from the first next word candidate list in data structure 300 may be displayed as higher ranking choices than words provided from the dictionary stored in memory 220. In this example, consistent with the invention, the second next word candidate list may contain any number of words, as the dictionary may provide all stored words that are compatible with the received input, however only a given number of words may be displayed via display 140 at any one time. If, for example, a user desires to see other words not shown or visible, the user may use control keys 120, for example, to scroll through the list. In the example shown in FIG. 5F, the maximum number of words displayed at any one time may be 5 words. In this example, if the user desires to see other candidate words provided in the second next word candidate list that may not be currently displayed, the user may make these other candidate words visible by scrolling through the list.

### CONCLUSION

Implementations consistent with principles of the invention may provide a next word candidate list to a user of a communication device to aid the user in entering character sequences into the communication device.

The foregoing description of preferred embodiments of the invention provides illustration and description, but is not intended to be exhaustive or to limit the invention to the precise form disclosed. Modifications and variations are possible in light of the above teachings or may be acquired from practice of the invention. For example, while the above description indicates that a dictionary may be used to supplement a second next word candidate list, it will be appreciated that in other implementations consistent with the invention, the dictionary may also supplement the first next word candidate list. However, as described above, the words from data structure 300 may be ranked higher than words from the dictionary.

While a series of acts has been described with regard to FIG. 4, the order of the acts may be modified in other implementations consistent with the principles of the invention. Further, non-dependent acts may be performed in parallel.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as a processor, a microprocessor, an application specific integrated circuit or a field programmable gate array, software, or a combination of hardware and software.

It should be emphasized that the term “comprises/comprising” when used in this specification and/or claims is taken to specify the presence of stated features, integers, steps or components but does not preclude the presence or addition of one or more other features, integers, steps, components or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method comprising:
receiving a word;
providing a first next word candidate list based on the received word;
receiving an input from a user; and
providing a second next word candidate list to the user based on the received input, at least one word in the second next word candidate list being selected from a predetermined list of words that is associated with the received word.

2. The method of claim 1, wherein the input from a user is a character.

3. The method of claim 1, wherein the providing the first next word candidate list includes retrieving the first next word candidate list from memory.

4. The method of claim 1, wherein providing the second next word candidate list to the user includes providing words selected from a dictionary.

5. The method of claim 1, wherein providing the second next word candidate list to the user includes providing words that remain after filtering the first next word candidate list.

6. A communication device comprising:
a memory to store a plurality of first next word candidate lists;
a display; and
logic configured to:
receive a word;
provide one first next word candidate list of the plurality of first next word candidate lists based on the received word;
receive an input from a user;
provide a second next word candidate list based on the received input from a user, at least one word in the second next word candidate list being selected from a predetermined list of words associated with the received word; and
cause at least a portion of the second next word candidate list to be displayed by the display.

7. The communication device of claim 6, wherein the received input from a user is a character.

8. The communication device of claim 6, wherein the logic is further configured to:
receive a selected word from the second next word candidate list.

9. The communication device of claim 6, wherein the second next word candidate list is scrollable.

10. The communication device of claim 6, wherein the logic is further configured to: provide words to the second next word candidate list from a dictionary.

11. A computer readable medium having stored thereon a plurality of sequences of instructions which, when executed by at least one processor, cause the processor to:
receive a word;
provide a first next word candidate list based on the received word; and
provide a second next word candidate list based on a character input by a user, at least one word in the second next word candidate list being selected from a list associated with the received word.

12. The computer readable medium of claim 11, further comprising instructions to cause the processor to:
provide words into the second next word candidate list from a dictionary.

13. The computer readable medium of claim 11, further comprising instructions to cause the processor to:
remove words from the list associated with the received word based on the character input by a user.

14. The computer readable medium of claim 13, further comprising instructions to cause the processor to:
place words from the first next word candidate list into the second next word candidate list.

15. The computer readable medium of claim 11, wherein the first next word candidate list is stored in memory.

16. A method comprising:
receiving a character sequence;
providing a first next word candidate list based on the received character sequence, the first next word candidate list being determined via a first technique;
receiving input from a user; and
providing a second next word candidate list, at least one character sequence in the second next word candidate list being determined via the first technique.

17. The method of claim 16, wherein providing the second next word candidate list includes providing at least one character sequence determined via a second technique.

18. The method of claim 17, wherein providing the second next word candidate list includes displaying at least one character sequence provided via the first technique as a higher ranking choice than at least one character sequence provided via the second technique.

19. A communication device comprising:
a memory; and
logic configured to:
receive a word,
provide a first next word candidate list from the memory based on the received word, the first next word candidate list being determined via a first technique;
receive a character input from a user; and
provide a second next word candidate list based on the received character input from a user, at least one word in the second next word candidate list being determined via the first technique.

20. The communication device of claim 19, wherein the logic is further configured to:
provide at least one word into the second next word candidate list determined via a second technique; and
display the second next word candidate list wherein the at least one word provided via the first technique is displayed as a higher ranking choice than at least one word provided via the second technique.
